(19) United States
(12) Patent Application Publication
(10) Pub. No.: US 2026/0192421 A1
(43) Pub. Date: Jul. 9, 2026

(54) TORQUE WRENCH APPARATUS

(71) Applicant: MATATAKITOYO TOOL CO., LTD., Taichung City (TW)

(72) Inventor: Yi-Min WU, Taichung City (TW)

(21) Appl. No.: 19/009,329

(22) Filed: Jan. 3, 2025

(51) Int. Cl. B25B 23/142

(52) U.S. Cl. CPC B25B 23/1425

(57) ABSTRACT

A torque wrench apparatus includes a torque wrench body, a torque wrench head, a microcontroller, and a torque reminder selection circuit. The torque reminder selection circuit is configured to transmit a torque reminder selection signal to the microcontroller. The microcontroller is configured to receive the torque reminder selection signal to provide a torque reminder lower limit value and a torque reminder upper limit value. The torque reminder upper limit value is greater than the torque reminder lower limit value.

### BACKGROUND OF THE DISCLOSURE

### Technical Field

The present disclosure relates to a wrench apparatus, and especially relates to a torque wrench apparatus.

### Description of Related Art

A related art torque wrench apparatus is used to lock a torqued object. The related art torque wrench apparatus may set a torque reminder lower limit value and a torque reminder upper limit value. When a torque applied by the related art torque wrench apparatus to the torqued object is greater than the torque reminder lower limit value and less than the torque reminder upper limit value, the related art torque wrench apparatus may emit a light reminder or a sound reminder to remind the user, which is very convenient.

Although the related art torque wrench apparatus is very convenient, setting the torque reminder lower limit value and the torque reminder upper limit value is not simple, which is a pity.

### SUMMARY OF THE INVENTION

In order to solve the above-mentioned problems, an object of the present disclosure is to provide a torque wrench apparatus.

In order to achieve the object of the present disclosure mentioned above, the torque wrench apparatus of the present disclosure includes a torque wrench body, a torque wrench head, a microcontroller, and a torque reminder selection circuit. The torque wrench head is detachably assembled to the torque wrench body. The microcontroller is arranged in the torque wrench body. The torque reminder selection circuit is electrically connected to the microcontroller. Moreover, the torque reminder selection circuit is configured to transmit a torque reminder selection signal to the microcontroller. The microcontroller is configured to receive the torque reminder selection signal to provide a torque reminder lower limit value and a torque reminder upper limit value. The torque reminder upper limit value is greater than the torque reminder lower limit value.

Moreover, in an embodiment of the torque wrench apparatus of the present disclosure mentioned above, the torque reminder selection circuit includes a first torque reminder selection button and a second torque reminder selection button. The first torque reminder selection button is electrically connected to the microcontroller. The second torque reminder selection button is electrically connected to the microcontroller. Moreover, in response to the first torque reminder selection button being pressed, the first torque reminder selection button is configured to transmit a first torque reminder selection signal to the microcontroller, and the microcontroller is configured to receive the first torque reminder selection signal to provide a first torque reminder lower limit value and a first torque reminder upper limit value, and the first torque reminder upper limit value is greater than the first torque reminder lower limit value. Moreover, in response to the second torque reminder selection button being pressed, the second torque reminder selection button is configured to transmit a second torque reminder selection signal to the microcontroller, and the microcontroller is configured to receive the second torque reminder selection signal to provide a second torque reminder lower limit value and a second torque reminder upper limit value, and the second torque reminder upper limit value is greater than the second torque reminder lower limit value. Moreover, the first torque reminder lower limit value and the second torque reminder lower limit value are different from each other. The first torque reminder upper limit value and the second torque reminder upper limit value are different from each other.

Moreover, in an embodiment of the torque wrench apparatus of the present disclosure mentioned above, the torque wrench apparatus is applied to a torqued object. The torque wrench apparatus further includes a torque sensor, a torque reminder circuit, and a clear button. The torque sensor is electrically connected to the microcontroller and arranged in the torque wrench body. The torque reminder circuit is electrically connected to the microcontroller and arranged in the torque wrench body. The clear button is electrically connected to the microcontroller. Moreover, in response to the first torque reminder selection button being pressed and the clear button failing to be pressed: the first torque reminder selection button is configured to transmit the first torque reminder selection signal to the microcontroller; the torque sensor is configured to sense a torque applied by the torque wrench apparatus to the torqued object to generate a torque sensing signal; the torque sensing signal includes a torque sensing value; after the torque sensor generates the torque sensing signal, the torque sensor is configured to transmit the torque sensing signal to the microcontroller; after the microcontroller receives the first torque reminder selection signal and the torque sensing signal, the microcontroller is configured to compare the torque sensing value and the first torque reminder lower limit value, and the microcontroller is configured to compare the torque sensing value and the first torque reminder upper limit value; in response to the torque sensing value being greater than the first torque reminder lower limit value and less than the first torque reminder upper limit value, the microcontroller is configured to drive the torque reminder circuit to emit a green light.

Moreover, in an embodiment of the torque wrench apparatus of the present disclosure mentioned above, the torque wrench apparatus includes a plurality of the torque wrench heads. Moreover, each of the torque wrench heads includes an identification color. A plurality of the identification colors of the torque wrench heads are different from each other. The first torque reminder selection button includes a first button color. The second torque reminder selection button includes a second button color. The first button color of the first torque reminder selection button and the second button color of the second torque reminder selection button are different from each other. The identification color of the torque wrench head assembled to the torque wrench body and the first button color of the first torque reminder selection button are the same, and then the first torque reminder selection button is pressed.

Moreover, in an embodiment of the torque wrench apparatus of the present disclosure mentioned above, in response to the first torque reminder selection button being pressed and the clear button being pressed for a duration that is less than a predetermined time: the first torque reminder selection button is configured to transmit the first torque reminder selection signal to the microcontroller; the clear button is configured to transmit a clear signal to the microcontroller; after the microcontroller receives the first torque reminder selection signal and the clear signal, the microcontroller is configured to adjust the first torque reminder lower limit value and the first torque reminder upper limit value.

Moreover, in an embodiment of the torque wrench apparatus of the present disclosure mentioned above, the torque reminder circuit includes a green light emitting diode electrically connected to the microcontroller and arranged in the torque wrench body. Moreover, in response to the torque sensing value being greater than the first torque reminder lower limit value and less than the first torque reminder upper limit value, the microcontroller is configured to drive the green light emitting diode to emit the green light.

Moreover, in an embodiment of the torque wrench apparatus of the present disclosure mentioned above, the torque reminder circuit further includes a yellow light emitting diode and a red light emitting diode. The yellow light emitting diode is electrically connected to the microcontroller and arranged in the torque wrench body. The red light emitting diode is electrically connected to the microcontroller and arranged in the torque wrench body. Moreover, in response to the torque sensing value being less than or equal to the first torque reminder lower limit value, the microcontroller is configured to drive the yellow light emitting diode to emit a yellow light. In response to the torque sensing value being greater than or equal to the first torque reminder upper limit value, the microcontroller is configured to drive the red light emitting diode to emit a red light.

Moreover, in an embodiment of the torque wrench apparatus of the present disclosure mentioned above, the torque wrench apparatus further includes a buzzer electrically connected to the microcontroller and arranged in the torque wrench body. Moreover, in response to the torque sensing value being greater than the first torque reminder lower limit value and less than the first torque reminder upper limit value, the microcontroller is configured to drive the buzzer to emit a sound.

Moreover, in an embodiment of the torque wrench apparatus of the present disclosure mentioned above, each of the torque wrench heads is engraved with a wrench opening size. A plurality of the wrench opening sizes of the torque wrench heads are different from each other. The wrench opening size is associated with the identification color.

Moreover, in an embodiment of the torque wrench apparatus of the present disclosure mentioned above, the torque wrench head is an adjustable wrench head. The torque wrench head includes a plurality of identification colors. The identification colors are different from each other. The first torque reminder selection button includes a first button color. The second torque reminder selection button includes a second button color. The first button color of the first torque reminder selection button and the second button color of the second torque reminder selection button are different from each other. An opening of the torque wrench head is adjusted to correspondingly indicate that the identification color is the same as the first button color of the first torque reminder selection button, and then the first torque reminder selection button is pressed.

The advantage of the present disclosure is to easily set the torque reminder lower limit value and the torque reminder upper limit value of the torque wrench.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows a block diagram of the first embodiment of the torque wrench apparatus of the present disclosure.

FIG. 2 shows a block diagram of the second embodiment of the torque wrench apparatus of the present disclosure.

FIG. 3 shows a schematic diagram of an embodiment of the torque wrench head of FIG. 2.

FIG. 4 shows a block diagram of the third embodiment of the torque wrench apparatus of the present disclosure.

FIG. 5 shows a schematic diagram of an embodiment of the torque wrench head of FIG. 4.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

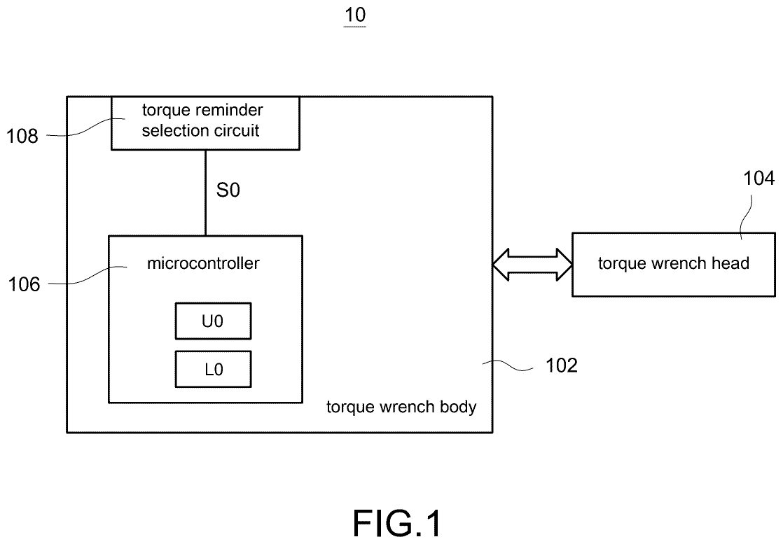

FIG. 1 shows a block diagram of the first embodiment of the torque wrench apparatus 10 of the present disclosure. The torque wrench apparatus 10 of the present disclosure includes a torque wrench body 102, a torque wrench head 104, a microcontroller 106, and a torque reminder selection circuit 108. The torque wrench head 104 is detachably assembled to the torque wrench body 102. The microcontroller 106 is arranged in the torque wrench body 102. The torque reminder selection circuit 108 is electrically connected to the microcontroller 106. The torque reminder selection circuit 108 is configured to transmit a torque reminder selection signal S0 to the microcontroller 106. The microcontroller 106 is configured to receive the torque reminder selection signal S0 to provide a torque reminder lower limit value L0 and a torque reminder upper limit value U0. The torque reminder upper limit value U0 is greater than the torque reminder lower limit value L0.

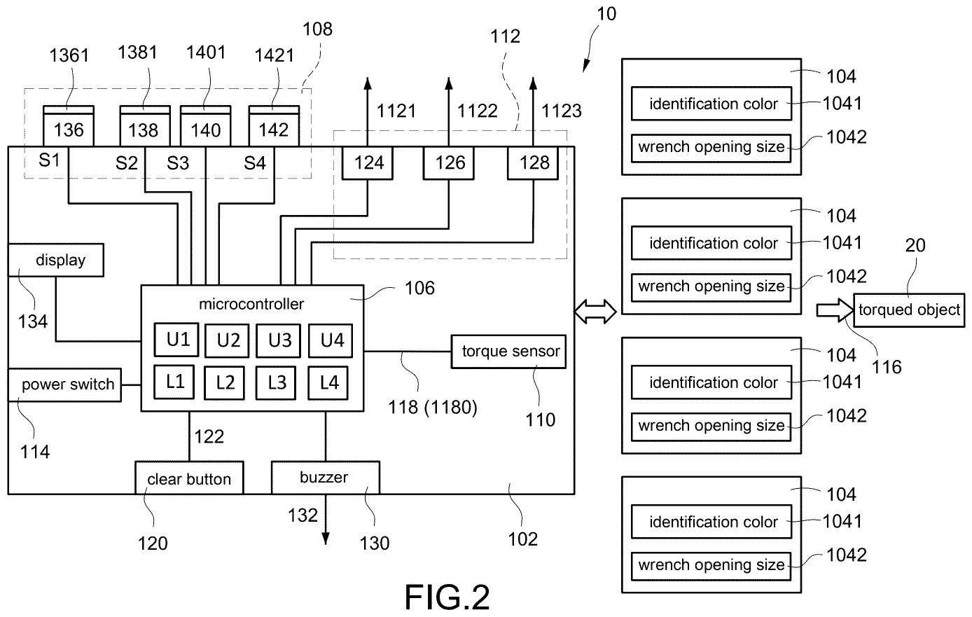

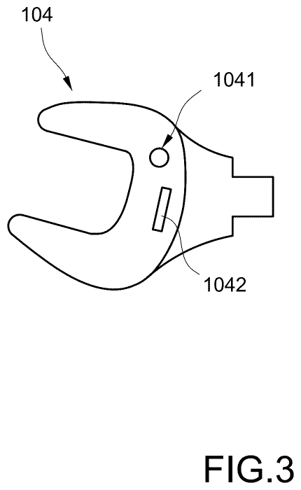

FIG. 2 shows a block diagram of the second embodiment of the torque wrench apparatus 10 of the present disclosure. The descriptions of the elements shown in FIG. 2 which are the same as the elements shown in FIG. 1 are not repeated here for brevity. FIG. 3 shows a schematic diagram of an embodiment of the torque wrench head 104 of FIG. 2. The torque wrench apparatus 10 is applied to (namely, is used to lock) a torqued object 20 (for example, a nut or a bolt).

The torque wrench apparatus 10 further includes a torque reminder circuit 112, a torque sensor 110, a buzzer 130, a clear button 120, and a power switch 114. The torque reminder selection circuit 108 includes a first torque reminder selection button 136, a second torque reminder selection button 138, a third torque reminder selection button 140, and a fourth torque reminder selection button 142. The torque reminder circuit 112 includes a green light emitting diode 124, a yellow light emitting diode 126, and a red light emitting diode 128.

The first torque reminder selection button 136, the second torque reminder selection button 138, the third torque reminder selection button 140, the fourth torque reminder selection button 142, the clear button 120, and the power switch 114 are electrically connected to the microcontroller 106. The torque reminder circuit 112 (namely, the green light emitting diode 124, the yellow light emitting diode 126, and the red light emitting diode 128), the torque sensor 110, and the buzzer 130 are electrically connected to the microcontroller 106 and arranged in the torque wrench body 102. The torque sensor 110 is, for example but not limited to, a strain gauge.

The torque wrench apparatus 10 includes a plurality of the torque wrench heads 104. For example, as shown in FIG. 2, the torque wrench apparatus 10 includes four torque wrench heads 104, but the torque wrench body 102 is assembled with only one torque wrench head 104 at a time, and the other three torque wrench heads 104 are placed in a tool box (not shown in FIG. 2 or FIG. 3). According to the usage requirement, a user (not shown in FIG. 2 or FIG. 3) may assemble any one of the four torque wrench heads 104 to the torque wrench body 102.

Each of the torque wrench heads 104 includes an identification color 1041 (for example, a color dot engraved on the torque wrench head 104). A plurality of the identification colors 1041 of the torque wrench heads 104 are different from each other. For example, in FIG. 2, the identification colors 1041 of the torque wrench heads 104 from top to bottom are yellow, black, red, and white respectively. Each of the torque wrench heads 104 is further engraved with a wrench opening size 1042. A plurality of the wrench opening sizes 1042 of the torque wrench heads 104 are different from each other. The wrench opening size 1042 is associated with the identification color 1041. For example, in FIG. 2, the wrench opening sizes 1042 engraved on the torque wrench heads 104 from top to bottom are 17, 22, 26, and 29 respectively (representing 17 mm, 22 mm, 26 mm, and 29 mm respectively).

The first torque reminder selection button 136 includes a first button color 1361. The second torque reminder selection button 138 includes a second button color 1381. The third torque reminder selection button 140 includes a third button color 1401. The fourth torque reminder selection button 142 includes a fourth button color 1421. The first button color 1361, the second button color 1381, the third button color 1401, and the fourth button color 1421 are different from each other. For example, in FIG. 2, the first button color 1361, the second button color 1381, the third button color 1401, and the fourth button color 1421 are yellow, black, red, and white respectively.

An embodiment of how to use the torque wrench apparatus 10 of the present disclosure is as follows:

First, the torque wrench heads 104 are placed in the tool box without being assembled to the torque wrench body 102. The user visually inspects the torqued object 20 to determine the torque wrench head 104 which is suitable. For example, if the length of the opposite sides of the torqued object 20 is about 17 mm, the user sees that the first torque wrench head 104 from top to bottom in FIG. 2 is engraved with the wrench opening size 1042 as 17 (representing 17mm), and the user assembles the first torque wrench head 104 from top to bottom in FIG. 2 to the torque wrench body 102. As mentioned above, the identification color 1041 of the first torque wrench head 104 from top to bottom in FIG. 2 is yellow.

Next, the user presses the first torque reminder selection button 136 having the first button color 1361 which is also yellow; namely, the identification color 1041 (yellow) of the torque wrench head 104 assembled to the torque wrench body 102 is the same as the first button color 1361 (yellow) of the first torque reminder selection button 136, and then the first torque reminder selection button 136 is pressed. In response to the first torque reminder selection button 136 being pressed, the first torque reminder selection button 136 is configured to transmit a first torque reminder selection signal S1 to the microcontroller 106.

Then, the microcontroller 106 is configured to receive the first torque reminder selection signal S1; at this time, if the clear button 120 fails to be pressed, the microcontroller 106 is configured to provide a first torque reminder lower limit value L1 and a first torque reminder upper limit value U1 corresponding to the first torque reminder selection signal S1. The first torque reminder upper limit value U1 is greater than the first torque reminder lower limit value L1. Then, the user uses the torque wrench apparatus 10 to lock the torqued object 20.

During the locking process, the torque sensor 110 is configured to sense a torque 116 applied by the torque wrench apparatus 10 to the torqued object 20 to generate a torque sensing signal 118. The torque sensing signal 118 includes a torque sensing value 1180. After the torque sensor 110 generates the torque sensing signal 118, the torque sensor 110 is configured to transmit the torque sensing signal 118 to the microcontroller 106. After the microcontroller 106 receiving the first torque reminder selection signal S1 and the torque sensing signal 118, the microcontroller 106 is configured to compare the torque sensing value 1180 and the first torque reminder lower limit value L1, and the microcontroller 106 106 is configured to compare the torque sensing value 1180 and the first torque reminder upper limit value U1.

In response to the torque sensing value 1180 being greater than the first torque reminder lower limit value L1 and being less than the first torque reminder upper limit value U1, the microcontroller 106 is configured to drive the green light emitting diode 124 to emit a green light 1121, and the microcontroller 106 is configured to drive the buzzer 130 to emit a sound 132. Therefore, the user may know that the torque sensing value 1180 is greater than the first torque reminder lower limit value L1 and is less than the first torque reminder upper limit value U1 (representing that the strength of the torque 116 locking the torqued object 20 is appropriate); at this time, the user may stop applying force.

In response to the torque sensing value 1180 being less than or equal to the first torque reminder lower limit value L1, the microcontroller 106 is configured to drive the yellow light emitting diode 126 to emit a yellow light 1122. Therefore, the user may know that the torque sensing value 1180 is less than or equal to the first torque reminder lower limit value L1 (representing that the strength of the torque 116 locking the torqued object 20 is not strong enough). In response to the torque sensing value 1180 being greater than or equal to the first torque reminder upper limit value U1, the microcontroller 106 is configured to drive the red light emitting diode 128 to emit a red light 1123. Therefore, the user may know that the torque sensing value 1180 is greater than or equal to the first torque reminder upper limit value U1 (representing that the strength of the torque 116 locking the torqued object 20 is too strong).

Similarly, if the length of the opposite sides of the torqued object 20 is about 22 mm, the user may assemble the second torque wrench head 104 (engraved with 22) from top to bottom in FIG. 2 to the torque wrench body 102. As mentioned above, the identification color 1041 of the second torque wrench head 104 from top to bottom in FIG. 2 is black. Then, the user presses the second torque reminder selection button 138 having the second button color 1381 which is also black, so that the second torque reminder selection button 138 is configured to transmit a second torque reminder selection signal S2 to the microcontroller 106, and the microcontroller 106 is configured to receive the second torque reminder signal S2 to provide a second torque reminder lower limit value L2 and a second torque reminder upper limit value U2. The second torque reminder upper limit value U2 is greater than the second torque reminder lower limit value L2.

If the length of the opposite sides of the torqued object 20 is about 26 mm, the user may assemble the third torque wrench head 104 (engraved with 26) from top to bottom in FIG. 2 to the torque wrench body 102. As mentioned above, the identification color 1041 of the third torque wrench head 104 from top to bottom in FIG. 2 is red. Then, the user presses the third torque reminder selection button 140 having the third button color 1401 which is also red, so that the third torque reminder selection button 140 is configured to transmit a third torque reminder selection signal S3 to the microcontroller 106, and the microcontroller 106 is configured to receive the third torque reminder selection signal S3 to provide a third torque reminder lower limit value L3 and a third torque reminder upper limit value U3. The third torque reminder upper limit value U3 is greater than the third torque reminder lower limit value L3.

If the length of the opposite sides of the torqued object 20 is about 29 mm, the user may assemble the fourth torque wrench head 104 (engraved with 29) from top to bottom in FIG. 2 to the torque wrench body 102. As mentioned above, the identification color 1041 of the fourth torque wrench head 104 from top to bottom in FIG. 2 is white. Then, the user presses the fourth torque reminder selection button 142 having the fourth button color 1421 which is also white, so that the fourth torque reminder selection button 142 is configured to transmit a fourth torque reminder selection signal S4 to the microcontroller 106, and the microcontroller 106 is configured to receive the fourth torque reminder selection signal S4 to provide a fourth torque reminder lower limit value L4 and a fourth torque reminder upper limit value U4. The fourth torque reminder upper limit value U4 is greater than the fourth torque reminder lower limit value L4.

The first torque reminder lower limit value L1, the second torque reminder lower limit value L2, the third torque reminder lower limit value L3, and the fourth torque reminder lower limit value L4 are different from each other; for example, they are 13 Nm, 37 Nm, 50 Nm, and 60 Nm respectively. The first torque reminder upper limit value U1, the second torque reminder upper limit value U2, the third torque reminder upper limit value U3, and the fourth torque reminder upper limit value U4 are different from each other; for example, they are 23 Nm, 47 Nm, 60 Nm, and 70 Nm respectively.

Moreover, in response to the first torque reminder selection button 136 being pressed and the clear button 120 failing to be pressed: the microcontroller 106 is configured to maintain the first torque reminder lower limit value L1 and the first torque reminder upper limit value U1 as fixed each time the first torque reminder selection signal S1 is received. Namely, if the first torque reminder selection button 136 is pressed and the clear button 120 fails to be pressed, no matter how many times the first torque reminder selection button 136 is pressed, the first torque reminder lower limit value L1 and the first torque reminder upper limit value U1 are fixed.

In the above content, the microcontroller 106 has built-in recommended (optimal) torque reminder lower limit value and torque reminder upper limit value corresponding to the wrench opening size 1042. For example, for the torque wrench head 104 having the wrench opening size 1042 engraved as 17, the first torque reminder lower limit value L1 and the first torque reminder upper limit value U1 provided by the microcontroller 106 are 13 Nm and 23 Nm, respectively. However, the user may also modify these values, and the first torque reminder lower limit value L1 and the first torque reminder upper limit value U1 are taken as an example and are described as follows:
First, the user presses the first torque reminder selection button 136, so that the first torque reminder selection button 136 is configured to transmit the first torque reminder selection signal S1 to the microcontroller 106. Then, the user presses the clear button 120 and the clear button 120 is pressed for a duration that is less than a predetermined time (which is a short press; for example, less than 0.5 second), so that the clear button 120 is configured to transmit a clear signal 122 to the microcontroller 106. After the microcontroller 106 receives the first torque reminder selection signal S1 and the clear signal 122, the microcontroller 106 is configured to adjust the first torque reminder lower limit value L1 and the first torque reminder upper limit value U1.

Moreover, that the microcontroller 106 is configured to adjust the first torque reminder lower limit value L1 and the first torque reminder upper limit value U1 includes: the microcontroller 106 is configured to first clear the first torque reminder lower limit value L1 and the first torque reminder upper limit value U1, and then the microcontroller 106 is configured to set (for example, increase) the first torque reminder lower limit value L1 and the first torque reminder upper limit value U1 based on a number of times that the first torque reminder selection signal S1 is received by the microcontroller 106 (namely, the number of times that the first torque reminder selection button 136 is pressed). Finally, in response to the microcontroller 106 sensing that the duration of pressing the clear button 120 is greater than or equal to the predetermined time (namely, the clear button 120 is pressed for a long time), the microcontroller 106 is configured to finish adjusting the first torque reminder lower limit value L1 and the first torque reminder upper limit value U1, and the first torque reminder lower limit value L1 and the first torque reminder upper limit value U1 are stored. During the adjustment process, the user may press (namely, short press) the clear button 120 again to restart.

After the first torque reminder lower limit value L1 and the first torque reminder upper limit value U1 are adjusted, the user may also directly use the torque wrench apparatus 10 having the first torque reminder lower limit value L1 and the first torque reminder upper limit value U1 which are adjusted to lock the torqued object 20.

Moreover, the torque wrench apparatus 10 further includes a display 134 electrically connected to the microcontroller 106. The microcontroller 106 is configured to drive the display 134 to display the torque sensing value 1180, the first torque reminder lower limit value L1, and the first torque reminder upper limit value U1 (or the second torque reminder lower limit value L2 and the second torque reminder upper limit value U2, or the third torque reminder lower limit value L3 and the third torque reminder upper limit value U3, or the fourth torque reminder lower limit value L4 and the fourth torque reminder upper limit value U4). Therefore, the user may know the torque sensing value 1180, the first torque reminder lower limit value L1, and the first torque reminder upper limit value U1 (or the second torque reminder lower limit value L2 and the second torque reminder upper limit value U2, or the third torque reminder lower limit value L3 and the third torque reminder upper limit value U3, or the fourth torque reminder lower limit value L4 and the fourth torque reminder upper limit value U4).

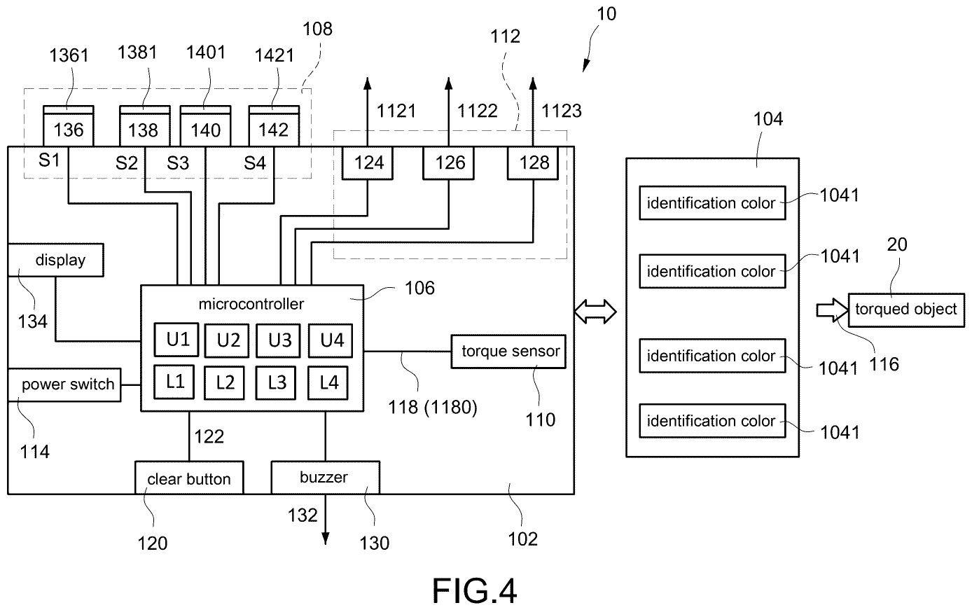

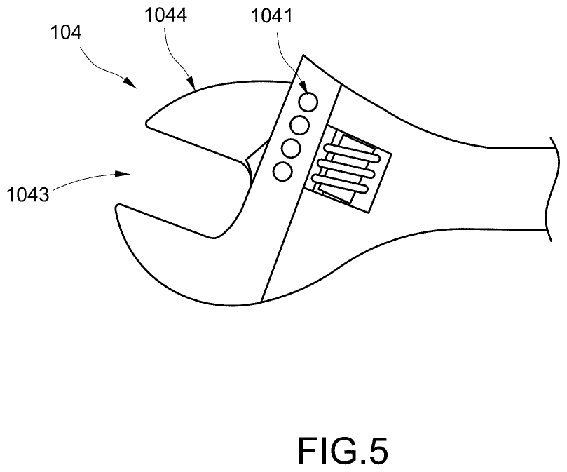

FIG. 4 shows a block diagram of the third embodiment of the torque wrench apparatus 10 of the present disclosure. The descriptions of the elements shown in FIG. 4 which are the same as the elements shown in FIG. 2 are not repeated here for brevity. FIG. 5 shows a schematic diagram of an embodiment of the torque wrench head 104 of FIG. 4. The difference from FIG. 2 is that FIG. 4 only includes one torque wrench head 104, and the torque wrench head 104 in FIG. 4 is an adjustable wrench head; the torque wrench head 104 includes a plurality of identification colors 1041; the identification colors 1041 are different from each other.

An opening 1043 of the torque wrench head 104 is adjusted to correspondingly indicate that the identification color 1041 is the same as the first button color 1361 of the first torque reminder selection button 136, and then the first torque reminder selection button 136 is pressed. Namely, the user first adjusts the opening 1043 of the torque wrench head 104 so that a lower jaw 1044 of the torque wrench head 104 correspondingly indicates the identification color 1041, such as yellow; then, the user presses the first torque reminder selection button 136 having the first button color 1361 which is also yellow.

The advantage of the present disclosure is to easily set the torque reminder lower limit value and the torque reminder upper limit value of the torque wrench.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. A torque wrench apparatus comprising:
a torque wrench body;
a torque wrench head detachably assembled to the torque wrench body;
a microcontroller arranged in the torque wrench body; and
a torque reminder selection circuit electrically connected to the microcontroller,
wherein the torque reminder selection circuit is configured to transmit a torque reminder selection signal to the microcontroller; the microcontroller is configured to receive the torque reminder selection signal to provide a torque reminder lower limit value and a torque reminder upper limit value; the torque reminder upper limit value is greater than the torque reminder lower limit value.

2. The torque wrench apparatus of claim 1, wherein the torque reminder selection circuit comprises:
a first torque reminder selection button electrically connected to the microcontroller; and
a second torque reminder selection button electrically connected to the microcontroller,
wherein in response to the first torque reminder selection button being pressed, the first torque reminder selection button is configured to transmit a first torque reminder selection signal to the microcontroller, and the microcontroller is configured to receive the first torque reminder selection signal to provide a first torque reminder lower limit value and a first torque reminder upper limit value, and the first torque reminder upper limit value is greater than the first torque reminder lower limit value;
wherein in response to the second torque reminder selection button being pressed, the second torque reminder selection button is configured to transmit a second torque reminder selection signal to the microcontroller, and the microcontroller is configured to receive the second torque reminder selection signal to provide a second torque reminder lower limit value and a second torque reminder upper limit value, and the second torque reminder upper limit value is greater than the second torque reminder lower limit value;
wherein the first torque reminder lower limit value and the second torque reminder lower limit value are different from each other; the first torque reminder upper limit value and the second torque reminder upper limit value are different from each other.

3. The torque wrench apparatus of claim 2, wherein the torque wrench apparatus is applied to a torqued object; the torque wrench apparatus further comprises:
a torque sensor electrically connected to the microcontroller and arranged in the torque wrench body;
a torque reminder circuit electrically connected to the microcontroller and arranged in the torque wrench body; and
a clear button electrically connected to the microcontroller,
wherein in response to the first torque reminder selection button being pressed and the clear button failing to be pressed: the first torque reminder selection button is configured to transmit the first torque reminder selection signal to the microcontroller; the torque sensor is configured to sense a torque applied by the torque wrench apparatus to the torqued object to generate a torque sensing signal; the torque sensing signal includes a torque sensing value; after the torque sensor generates the torque sensing signal, the torque sensor is configured to transmit the torque sensing signal to the microcontroller; after the microcontroller receives the first torque reminder selection signal and the torque sensing signal, the microcontroller is configured to compare the torque sensing value and the first torque reminder lower limit value, and the microcontroller is configured to compare the torque sensing value and the first torque reminder upper limit value; in response to the torque sensing value being greater than the first torque reminder lower limit value and less than the first torque reminder upper limit value, the microcontroller is configured to drive the torque reminder circuit to emit a green light.

4. The torque wrench apparatus of claim 3, comprising a plurality of the torque wrench heads, wherein each of the torque wrench heads comprises an identification color; a plurality of the identification colors of the torque wrench heads are different from each other; the first torque reminder selection button comprises a first button color; the second torque reminder selection button comprises a second button color; the first button color of the first torque reminder selection button and the second button color of the second torque reminder selection button are different from each other; the identification color of the torque wrench head assembled to the torque wrench body and the first button color of the first torque reminder selection button are the same, and then the first torque reminder selection button is pressed.

5. The torque wrench apparatus of claim 4, wherein in response to the first torque reminder selection button being pressed and the clear button being pressed for a duration that is less than a predetermined time: the first torque reminder selection button is configured to transmit the first torque reminder selection signal to the microcontroller; the clear button is configured to transmit a clear signal to the microcontroller; after the microcontroller receives the first torque reminder selection signal and the clear signal, the microcontroller is configured to adjust the first torque reminder lower limit value and the first torque reminder upper limit value.

6. The torque wrench apparatus of claim 5, wherein the torque reminder circuit comprises:
a green light emitting diode electrically connected to the microcontroller and arranged in the torque wrench body,
wherein in response to the torque sensing value being greater than the first torque reminder lower limit value and less than the first torque reminder upper limit value, the microcontroller is configured to drive the green light emitting diode to emit the green light.

7. The torque wrench apparatus of claim 6, wherein the torque reminder circuit further comprises:
a yellow light emitting diode electrically connected to the microcontroller and arranged in the torque wrench body; and
a red light emitting diode electrically connected to the microcontroller and arranged in the torque wrench body,
wherein in response to the torque sensing value being less than or equal to the first torque reminder lower limit value, the microcontroller is configured to drive the yellow light emitting diode to emit a yellow light; in response to the torque sensing value being greater than or equal to the first torque reminder upper limit value, the microcontroller is configured to drive the red light emitting diode to emit a red light.

8. The torque wrench apparatus of claim 7, further comprising:
a buzzer electrically connected to the microcontroller and arranged in the torque wrench body,
wherein in response to the torque sensing value being greater than the first torque reminder lower limit value and less than the first torque reminder upper limit value, the microcontroller is configured to drive the buzzer to emit a sound.

9. The torque wrench apparatus of claim 8, wherein each of the torque wrench heads is engraved with a wrench opening size; a plurality of the wrench opening sizes of the torque wrench heads are different from each other; the wrench opening size is associated with the identification color.

10. The torque wrench apparatus of claim 3, wherein the torque wrench head is an adjustable wrench head; the torque wrench head comprises a plurality of identification colors; the identification colors are different from each other; the first torque reminder selection button comprises a first button color; the second torque reminder selection button comprises a second button color; the first button color of the first torque reminder selection button and the second button color of the second torque reminder selection button are different from each other; an opening of the torque wrench head is adjusted to correspondingly indicate that the identification color is the same as the first button color of the first torque reminder selection button, and then the first torque reminder selection button is pressed.
